(19) United States
(12) Patent Application Publication
(10) Pub. No.: US 2012/0213282 A1
(43) Pub. Date: Aug. 23, 2012

(54) METHOD AND APPARATUS FOR ENCODING AND DECODING MULTI-VIEW VIDEO

(75) Inventors: Byeong-doo CHOI, Siheung-si (KR); Dae-sung CHO, Seoul (KR); Seung-soo JEONG, Seoul (KR)

(73) Assignee: SAMSUNG ELECTRONICS CO., LTD., Suwon-si (KR)

(21) Appl. No.: 13/401,264

(22) Filed: Feb. 21, 2012

(30) Foreign Application Priority Data
Feb. 21, 2011 (KR) 10-2011-0015033

(51) Int. Cl. H04N 7/32

(52) U.S. Cl. 375/240.16; 375/E07.243

(57) ABSTRACT

A method and apparatus for encoding and decoding a multi-view video by encoding and decoding a current block the multi-view image using a reference frame having a view different than a view of a current frame of the current block.

### CROSS-REFERENCE TO RELATED PATENT APPLICATION

This application claims priority from Korean Patent Application No. 10-2011-0015033, filed on Feb. 21, 2011, in the Korean Intellectual Property Office, the disclosure of which is incorporated herein by reference in its entirety.

### BACKGROUND

1. Field

Apparatuses and methods consistent with the exemplary embodiments relate to video encoding and decoding, and more particularly, to a method and apparatus for encoding a multi-view video image by predicting a motion vector of the multi-view video image, and a method and apparatus for decoding the multi-view video image.

2. Description of the Related Art

Multi-view video coding (MVC) involves processing a plurality of images having different views obtained from a plurality of cameras and compression-encoding a multi-view image by using temporal correlation and spatial correlation between inter-views of cameras.

In temporal prediction using the temporal correlation and inter-view prediction using the spatial correlation, motion of a current picture is predicted and compensated for in block units by using one or more reference pictures, so as to encode an image. In the temporal prediction and the inter-view prediction, the most similar block to a current block is searched for in a predetermined search range of the reference picture, and when the similar block is determined, residual data between the current block and the similar block is transmitted. By doing so, a data compression rate is increased.

### SUMMARY

The exemplary embodiments provide a method and apparatus for encoding and decoding a multi-view video to increase an image compression rate by providing a view direction skip mode when the multi-view video is coded.

According to an aspect of an exemplary embodiment, there is provided a method of encoding a multi-view video, the method including the operations of generating a view direction skip motion vector of a current block of the multi-view video, the current block having a first view and to be encoded by using a view direction motion vector of a block referring to a frame that has a second view and is previously encoded; performing motion compensation on the current block by referring to the frame having the second view based on the view direction skip motion vector; and encoding mode information about the view direction skip motion vector.

According to another aspect of an exemplary embodiment, there is provided a method of decoding a multi-view video, the method including the operations of decoding from a bitstream prediction mode information of a current block of the multi-view video, the current block having a first view; generating a view direction skip motion vector of the current block by using a view direction motion vector of a block referring to a frame that has a second view and is previously decoded; performing motion compensation on the current block by referring to the frame having the second view, based on the view direction skip motion vector; and restoring the current block by adding a motion compensation value of the current block and a residual value extracted from the bitstream.

According to another aspect of an exemplary embodiment, there is provided a video encoding apparatus for encoding a multi-view video, the video encoding apparatus including a prediction unit that generates a view direction skip motion vector of a current block of the multi-view video, the current block having a first view and to be encoded by using a view direction motion vector of a block referring to a frame that has a second view and is previously encoded and restored; a motion compensation unit that performs motion compensation on the current block by referring to the frame having the second view based on the view direction skip motion vector; and an entropy encoding unit encoding mode information about the view direction skip motion vector.

According to another aspect of an exemplary embodiment, there is provided a video decoding apparatus for decoding a multi-view video, the video decoding apparatus including an entropy decoding unit that decodes from a bitstream prediction mode information of a current block of the multi-view video, the current block having a first view; a motion compensation unit that, when the prediction mode information indicates a view direction skip mode, generates a view direction skip motion vector of the current block by using a view direction motion vector of an adjacent block from among adjacent blocks of the current block having the first view and being to be decoded, wherein the adjacent block refers to a frame that has a second view and is previously decoded, and that performs motion compensation on the current block by referring to the frame having the second view, based on the view direction skip motion vector; and a restoring unit that restores the current block by adding a motion compensation value of the current block and a residual value extracted from the bitstream.

### BRIEF DESCRIPTION OF THE DRAWINGS

The above and other aspects will become more apparent by describing in detail exemplary embodiments thereof with reference to the attached drawings in which:

FIG. 1 is a diagram illustrating a multi-view video sequence encoded by using a method of encoding a multi-view video, according to an exemplary embodiment;

FIG. 2 is a block diagram illustrating a configuration of a video encoding apparatus according to an exemplary embodiment;

FIG. 3 is a reference view for describing a prediction-encoding process performed in a view direction skip mode, according to an exemplary embodiment;

FIG. 4 is a reference view for describing a process of generating a view direction skip motion vector, according to an exemplary embodiment;

FIG. 5 is a reference view for describing a process of generating a view direction skip motion vector, according to another exemplary embodiment of;

FIG. 6 is a reference view for describing a process of generating a view direction skip motion vector, according to another exemplary embodiment;

FIG. 7 is a flowchart of a method of encoding a multi-view video, according to an exemplary embodiment;

FIG. 8 is a block diagram illustrating a video decoding apparatus according to an exemplary embodiment; and

FIG. 9 is a flowchart of a method of decoding a video, according to an exemplary embodiment.

### DETAILED DESCRIPTION OF THE EXEMPLARY EMBODIMENTS

Hereinafter, the exemplary embodiments will be described in detail with reference to the attached drawings.

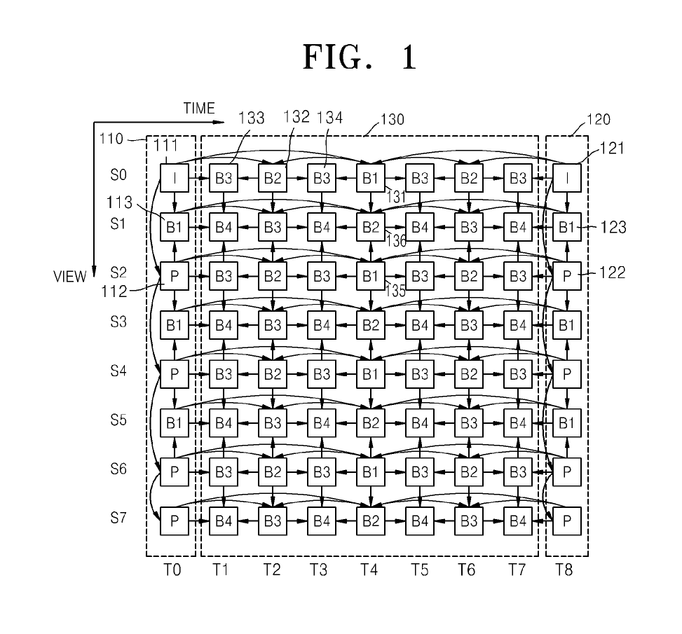

FIG. 1 is a diagram illustrating a multi-view video sequence encoded by using a method of encoding a multi-view video according to an exemplary embodiment.

Referring to FIG. 1, an X-axis is a time axis, and a Y-axis is a view axis. T0 through T8 of the X-axis indicate sampling times of an image, respectively, and S0 through S7 of the Y-axis indicate different views, respectively. In FIG. 1, each row indicates each image picture group that is input having the same view, and each column indicates multi-view images at a same time.

In multi-view image encoding, an intra-picture is periodically generated with respect to an image having a base view, and other pictures are prediction-encoded by performing temporal prediction or inter-view prediction based on generated intra pictures.

The temporal prediction uses the same view, i.e., temporal correlation between images of the same row in FIG. 1. For the temporal prediction, a prediction structure using a hierarchical B-picture may be used. The inter-view prediction uses images of the same time, i.e., spatial correlation between images of the same column. Hereinafter, a case of encoding image picture groups by using the hierarchical B-picture will be described. However, the method of encoding and decoding a multi-view video, according to the exemplary embodiment, may be applied to another multi-view video sequence having a different structure other than a hierarchical B-picture structure.

In order to perform prediction by using images of the same view, i.e., temporal correlation between images of the same row, a multi-view picture prediction structure using the hierarchical B-picture prediction-encodes an image picture group having the same view into bi-directional pictures (hereinafter, referred to as “B-pictures”) by using anchor pictures. Here, the anchor pictures indicate pictures included in columns 110 and 120 among the columns of FIG. 1, wherein the columns 110 and 120 are respectively at a first time T0 and a last time T8 and include intra-pictures. Except for the intra-pictures (hereinafter, referred to as “I-picture”), the anchor pictures are prediction-encoded by using only inter-view prediction. Pictures that are included in the rest of the columns 130 other than the columns 110 and 120 including the I-pictures are referred to as non-anchor pictures.

Hereinafter, a description will be provided for an example in which image pictures that are input for a predetermined time period having a first view S0 are encoded by using a hierarchical B-picture. From among the image pictures input having the first view S0, a picture 111 input at the first time T0 and a picture 121 input at the last time T8 are encoded as I-pictures. Next, a picture 131 input at a Time T4 is bi-directionally prediction-encoded by referring to the I-pictures 111 and 121 that are anchor pictures, and then is encoded as a B-picture. A picture 132 input at a Time T2 is bi-directionally prediction-encoded by using the I-picture 111 and the B-picture 131, and then is encoded as a B-picture. Similarly, a picture 133 input at a Time T1 is bi-directionally prediction-encoded by using the I-picture 111 and the B-picture 132, and a picture 134 input at a Time T3 is bi-directionally prediction-encoded by using the B-picture 132 and the B-picture 131. In this manner, since image sequences having the same view are bi-directionally prediction-encoded in a hierarchical manner by using anchor pictures, the image sequences encoded by using this prediction-encoding method are called hierarchical B-pictures. In Bn (n=1, 2, 3, and 4) of FIG. 1, n indicates a B-picture that is nₜₕ bi-directionally predicted. For example, B1 indicates a picture that is first bi-directionally predicted by using an anchor picture that is an I-picture or a P-picture. B2 indicates a picture that is bi-directionally predicted after the B1 picture, B3 indicates a picture that is bi-directionally predicted after the B2 picture, and B4 indicates a picture that is bi-directionally predicted after the B3 picture.

When the multi-view video sequence is encoded, an image picture group having the first view S0 that is a base view may be encoded by using the hierarchical B-picture. In order to encode image sequences having other views, first, by performing inter-view prediction using the I-pictures 111 and 121 having the first view S0, image pictures having odd views S2, S4, and S6, and an image picture having a last view S7 that are included in the anchor pictures 110 and 120 are prediction-encoded as P-pictures. Image pictures having even views S1, S3, and S5 included in the anchor pictures 110 and 120 are bi-directionally predicted by using an image picture having an adjacent view according to inter-view prediction, and are encoded as B-pictures. For example, the B-picture 113 that is input at a Time T0 having a second view S1 is bi-directionally predicted by using the I-picture 111 and a P-picture 112 having adjacent views S0 and S2.

When each of image pictures having all views and included in the anchor pictures 110 and 120 is encoded as any one of an I-picture, a B-picture, and a P-picture, as described above, the non-anchor pictures 130 are bi-directionally prediction-encoded by performing temporal prediction and inter-view prediction that use the hierarchical B-picture.

From among the non-anchor pictures 130, image pictures having the odd views S2, S4, and S6, and an image picture having the last view S7 are bi-directionally prediction-encoded by using anchor pictures having the same view according to temporal prediction using the hierarchical B-picture. From among the non-anchor pictures 130, image pictures having even views S1, S3, S5, and S7 are bi-directionally predicted by performing not only temporal prediction using the hierarchical B-picture but also performing inter-view prediction using pictures having adjacent views. For example, a picture 136 that is input at a Time T4 having the second view S1 is predicted by using anchor pictures 113 and 123, and pictures 131 and 135 having adjacent views.

As described above, the P-pictures that are included in the anchor pictures 110 and 120 are prediction-encoded by using an I-picture having a different view and input at the same time, or a previous P-picture. For example, a P-picture 122 that is input at a Time T8 at a third view S2 is prediction-encoded by using an I-picture 121 as a reference picture, wherein the I-picture 121 is input at the same time at a first view S0.

In the multi-view video sequence of FIG. 1, a P-picture or a B-picture is prediction-encoded by using a picture having a different view as a reference picture, wherein the picture is input at the same time. In prediction encoding modes, a skip mode and a direct mode determine a motion vector of a current block based on at least one motion vector of a block that is encoded before the current block, encode the current block based on the determined motion vector, and do not separately encode the motion vector as information with respect to the current block. In the direct mode, a residual block that is a difference between a current block and a prediction block generated by using a motion vector of an adjacent block of the current block is encoded as information with respect to a pixel value. On the other hand, in the skip mode, only syntax information indicating that a current block is regarded to be the same as a prediction block and thus is encoded in the skip mode is encoded.

The direct mode and the skip mode do not separately encode the motion vector and thus considerably increase a compression rate. However, according to the related art, the direct mode and the skip mode are applied only to an image sequence having the same view, i.e., the direct mode and the skip mode are applied only in a temporal direction and are not applied to an image sequence having difference views. Thus, the present exemplary embodiment provides a skip mode in which prediction encoding is performed by referring to a reference frame having a view different from a view of a current block encoded when a multi-view video sequence is encoded, and in which motion vector information about the current block is not separately encoded, so that a compression rate of a multi-view video is increased.

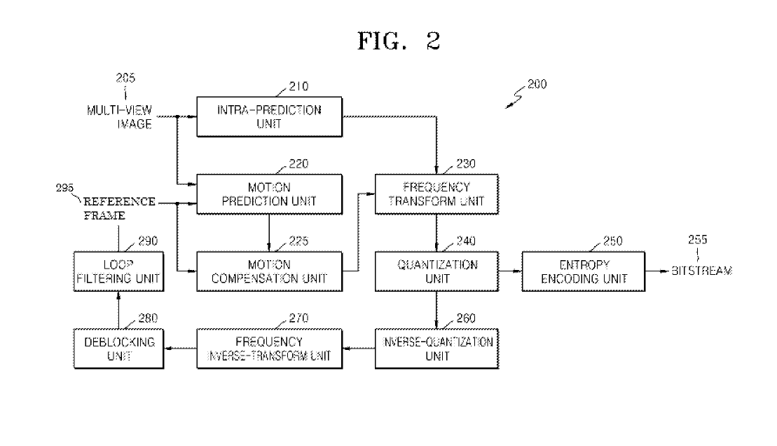

FIG. 2 is a block diagram illustrating a configuration of a video encoding apparatus 200 according to an exemplary embodiment.

Referring to FIG. 2, the video encoding apparatus 200 for encoding a multi-view image 205 includes an intra-prediction unit 210, a motion prediction unit 220, a motion compensation unit 225, a frequency transform unit 230, a quantization unit 240, an entropy encoding unit 250, an inverse-quantization unit 260, a frequency inverse-transform unit 270, a deblocking unit 280, and a loop filtering unit 290.

The intra-prediction unit 210 performs intra-prediction on blocks that are encoded as I-pictures in anchor pictures among a multi-view image, and the motion prediction unit 220 and the motion compensation unit 225 perform motion prediction and motion compensation, respectively, by referring to a reference frame that is included in an image sequence having the same view as an encoded current block and that has a different picture order count (POC), or by referring to a reference frame having a different view from the current block and having the same POC as the current block. In particular, as will be described later, the motion prediction unit 220 and the motion compensation unit 225 according to the present exemplary embodiment may predict the current block in a skip mode in which prediction encoding is performed by referring to a reference frame having a different view from the current block, and in which motion vector information about the current block is not separately encoded.

Data output from the intra-prediction unit 210, the motion prediction unit 220, and the motion compensation unit 225 passes through the frequency transform unit 230 and the quantization unit 240 and then is output as a quantized transform coefficient. The quantized transform coefficient is restored as data in a spatial domain by the inverse-quantization unit 260 and the frequency inverse-transform unit 270, and the restored data in the spatial domain is post-processed by the deblocking unit 280 and the loop filtering unit 290 and then is output as a reference frame 295. Here, the reference frame 295 may be an image sequence having a specific view and being previously encoded, compared to an image sequence having a different view in a multi-view image sequence. For example, an image sequence including an anchor picture and having a specific view is encoded prior to an image sequence having a different view, and is used as a reference picture when the image sequence having the different view is prediction-encoded in a view direction. The quantized transform coefficient may be output as a bitstream 255 by the entropy encoding unit 250.

Hereinafter, a detailed description is provided with respect to a process of encoding a current block in the skip mode when prediction-encoding is performed in a view direction.

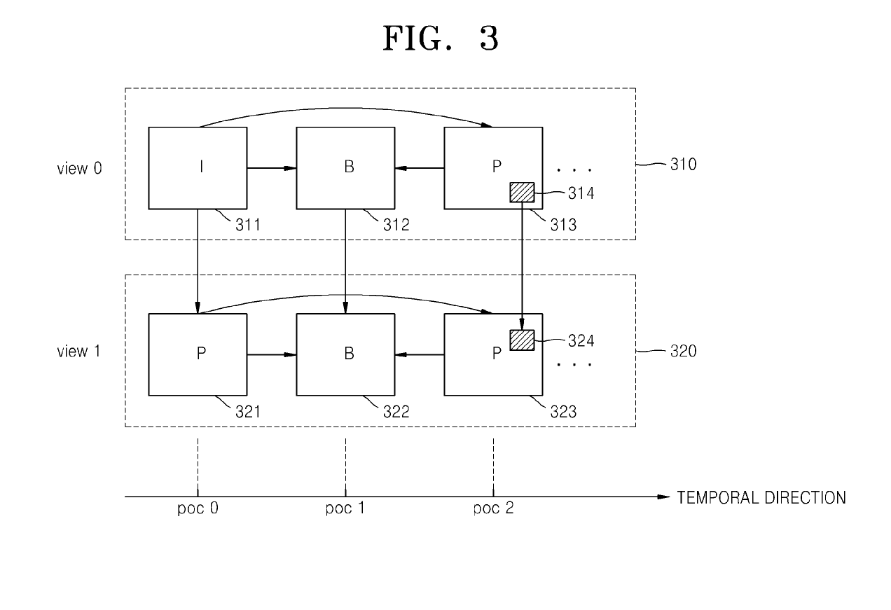

FIG. 3 is a reference view for describing a prediction-encoding process performed in a view direction skip mode, according to an exemplary embodiment.

Referring to FIG. 3, the video encoding apparatus 200 performs prediction-encoding on frames 311, 312, and 313 included in an image sequence 310 having a second view (view 0), and then restores the frames 311, 312, and 313 included in the image sequence 310 having the second view (view 0) which is encoded to be used as a reference frame for prediction-encoding of an image sequence having a different view. That is, the frames 311, 312, and 313 that are included in the image sequence 310 having the second view (view 0) are encoded and then restored before an image sequence (320), which includes frames 321, 322, and 323, having a first view (view 1). As illustrated in FIG. 3, the frames 311, 312, and 313 that are included in the image sequence 310 having the second view (view 0) may be frames that are prediction-encoded in a temporal direction by referring to other frames included in the image sequence 310, or may be frames that are previously encoded by referring to an image sequence having a different view (not shown) and then are restored. In FIG. 3, an arrow denotes a prediction direction indicating which reference frame is referred to predict each frame. For example, a P frame 323 having a first view (view 1) and including a current block 324 to be encoded may be prediction-encoded by referring to another P frame 321 having the same view or may be prediction-encoded by referring to the P frame 313 having a second view (view 0) and the same POC 2. A prediction-encoding process in frames included in an image sequence having the same view may be performed in the same manner as a prediction-encoding process according to the related art, and thus, hereinafter, a description is provided with respect to a view direction prediction-encoding process in which prediction-encoding is performed by referring to a reference frame having a different view.

The motion prediction unit 220 generates a view direction skip motion vector of the current block 324 by using a view direction motion vector of an adjacent block that refers to a frame having a second view (view 0) and being previously encoded and restored and that is from among adjacent blocks of the current block 324 having a first view (view 1). Here, the view direction motion vector denotes a motion vector indicating a reference frame having a different view, and the view direction skip motion vector denotes a vector used for motion compensation of a current block in the view direction skip mode according to the exemplary embodiment in which only mode information is transmitted as motion vector information of the current block 324, and actual motion vector information is not transmitted. In other words, the view direction skip motion vector denotes a vector used to determine a corresponding region of a view direction reference frame, wherein the vector is similar to a skip mode motion vector that is determined from an adjacent block of a current block in a temporal direction skip mode according to the related art.

When the motion prediction unit 220 determines the view direction skip motion vector of the current block 324, the motion compensation unit 225 determines a corresponding region 314 as a prediction value of the current block 324, wherein the corresponding region 314 is indicated by the view direction skip motion vector and is in the P frame 313 that is included in the image sequence 310 having a second view (view 0) and that has the same POC 2 as the P frame 323 including the current block 324. In the view direction skip mode, the corresponding region 314 is regarded as a value of the current block 324, so that only syntax information indicating the view direction skip mode is encoded. In a view direction direct mode, residual information that is a difference value between the corresponding region 314 and the current block 324 is transmitted as well as the syntax information indicating a direct mode.

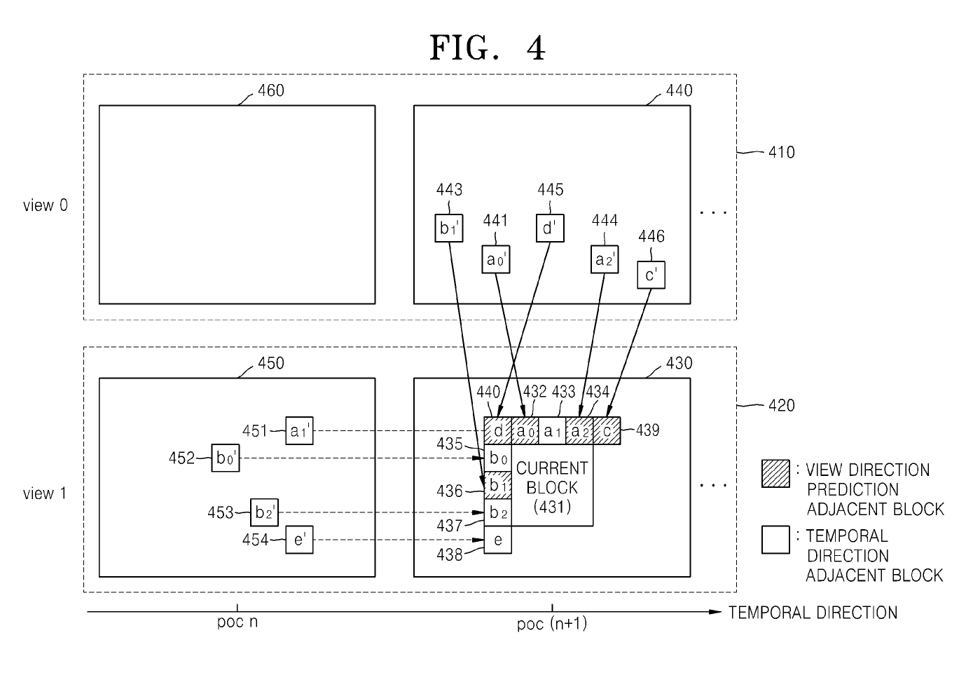

FIG. 4 is a reference view for describing a process of generating a view direction skip motion vector, according to an exemplary embodiment.

Referring to FIG. 4, it is assumed that frames 440 and 460 included in an image sequence 410 having a second view (view 0) are encoded and then restored prior to an image sequence 420 having a first view (view 1), and a frame 430 that includes a current block 431 to be encoded has a POC (n+1). Also, as illustrated in FIG. 4, it is assumed that, from among adjacent blocks 432 through 440 of the current block 431, each of a0 432, a2 434, b1 436, c 439, and d 440 is a view direction-predicted adjacent block that is prediction-encoded by referring to each of a0′ 441, a2′ 444, b1′ 443, c′ 446, and d′ 445 that are corresponding regions of a frame 440 having the same POC (n+1) and having a different view (view 0) from the frame 430 including the current block 431. Also, it is assumed that each of a1 433, b0 435, b2 437, and e 438 is a temporal direction-predicted adjacent block that is prediction-encoded by referring to each of a1′ 451, b0′ 452, b2′ 453, and e′ 454 that are corresponding regions of a frame 450 included in the image sequence 420 that has the same view as the current block 431 and has a different POC n.

As described above, the motion prediction unit 220 generates a view direction skip motion vector of the current block 431 by using a view direction motion vector of an adjacent block that refers to a frame having a second view (view 0) and being previously encoded and restored and that is from among adjacent blocks 432 through 440 of the current block 431 having a first view (view 1) and to be encoded. In more detail, the motion prediction unit 220 generates the view direction skip motion vector of the current block 431 by using view direction motion vectors of a0 432, a2 434, b1 436, c 439, and d 440 that are adjacent blocks referring to a reference frame 440 that has the same POC (n+1) and has a different view (view 0) from the frame 430 including the current block 431. As in the aforementioned example, in a case where adjacent blocks have a plurality of view direction motion vectors, a median value may be used so as to determine one view direction motion vector to be applied to the current block 431. For example, the motion prediction unit 220 may determine a first representative view direction motion vector mv_view1 among adjacent blocks a0 through a2 disposed above the current block 431, may determine a second representative view direction motion vector mv_view2 among adjacent blocks b0 through b2 disposed left to the current block 431, may determine a third representative view direction motion vector mv_view3 among blocks c, d, and e disposed at corners of the current block 431, and then may determine a median value of the first, second, and third representative view direction motion vectors mv_view1, mv_view2, and mv_view3 as a view direction skip motion vector of the current block 431.

As in the aforementioned example, in a case where a plurality of adjacent blocks a0 432 and a2 434 from among the adjacent blocks a0 through a2 disposed above the current block 431 have view direction motion vectors, the view direction motion vector of the adjacent block a0 432 that is first scanned may be determined as the first representative view direction motion vector mv_view1. Similarly, when it is assumed that, if a plurality of adjacent blocks c 439 and d 440 from among adjacent blocks 438, 439, and 440 disposed at corners of the current block 431 have view direction motion vectors, a plurality of pieces of motion prediction information of adjacent blocks at corners are read according to a predetermined scanning order, e.g., an order of c, d, and e, the view direction motion vector of the adjacent block c 439 that is first determined to have the view direction motion vector may be determined as the third representative view direction motion vector mv_view3. In a case where blocks disposed left to the current block 431, blocks disposed above the current block 431, and blocks disposed at corners of the current block 431 do not refer to the frame 440 having a second view (view 0), a median value may be calculated by setting a representative view direction motion vector as 0 with respect to adjacent blocks of a corresponding group. For example, in a case where a view direction-predicted adjacent block referring to the frame 440 does not exist in the adjacent blocks 435, 436, and 437 disposed left to the current block 431, a median value may be calculated by setting the second representative view direction motion vector mv_view2 as 0.

When the view direction skip motion vector of the current block 431 is determined, the motion compensation unit 225 determines a corresponding region as a prediction value of the current block 431, wherein the corresponding region is indicated by the view direction skip motion vector and is in the frame 440 having a second view (view 0). As described above, in the view direction skip mode, the corresponding region is regarded as a value of the current block 431, so that only syntax information indicating the view direction skip mode is encoded, and in a view direction direct mode, residual information that is a difference value between the corresponding region and the current block 431 is transmitted in addition to the syntax information indicating a direct mode.

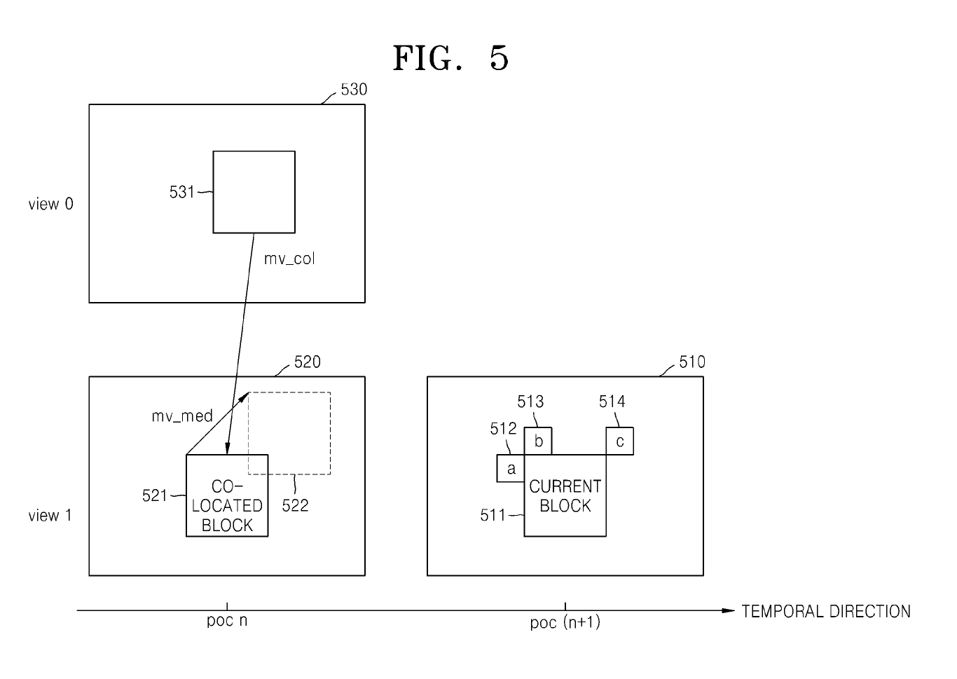

FIG. 5 is a reference view for describing a process of generating a view direction skip motion vector, according to another exemplary embodiment.

Referring to FIG. 5, it is assumed that a co-located block 521 of a frame 520 having the same view (view 1) as a current block 511 and having a different POC n from a POC (n+1) of a current frame 510 is a view direction-predicted block referring to a frame 530, which includes block 531, having a different view (view 0), and has a view direction motion vector mv_col. In this case, the motion prediction unit 220 may determine the view direction motion vector mv_col of the co-located block 521 as a view direction skip motion vector of the current block 511. Also, the motion prediction unit 220 may shift the co-located block 521 by using a temporal direction motion vector of an adjacent block that refers to the frame 520 and that is from among adjacent blocks of the current block 511, and may determine a view direction motion vector of a shifted corresponding block 522 as the view direction skip motion vector of the current block 511. For example, when it is assumed that adjacent blocks a 512, b 513, and c 514 of the current block 511 are temporal direction-predicted adjacent blocks referring to the frame 520, the motion prediction unit 220 may calculate a median value mv_med of the adjacent blocks a 512, b 513, and c 514, may determine the shifted corresponding block 522 by shifting the co-located block 521 by as much as the median value mv_med, and then may determine the view direction motion vector of the shifted corresponding block 522 as the view direction skip motion vector of the current block 511.

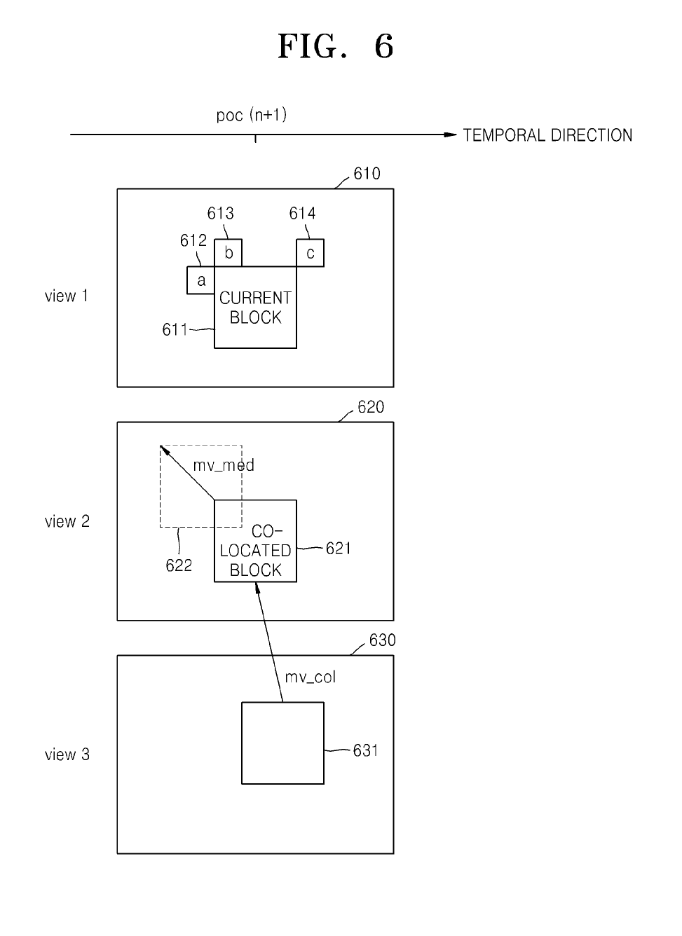

FIG. 6 is a reference view for describing a process of generating a view direction skip motion vector, according to another exemplary embodiment.

Referring to FIG. 6, it is assumed that a co-located block 621 of a frame 620 having a different view (view 2) from a view (view 1) of a current block 611 and having the same POC as a POC (n+1) of a current frame 610 is a view direction-predicted block referring to a frame 630 having a different view (view 3) and block 631, and has a view direction motion vector mv_col. In this case, the motion prediction unit 220 may determine the view direction motion vector mv_col of the co-located block 621 as a view direction skip motion vector of the current block 611. Also, the motion prediction unit 220 may shift the co-located block 621 by using a view direction motion vector of an adjacent block that refers to the frame 620 and that is from among adjacent blocks of the current block 611, and may determine a view direction motion vector of a shifted corresponding block 622 as the view direction skip motion vector of the current block 611. For example, when it is assumed that adjacent blocks a 612, b 613, and c 614 of the current block 611 are view direction-predicted adjacent blocks referring to the frame 620, the motion prediction unit 220 may calculate a median value mv_med of the adjacent blocks a 612, b 613, and c 614, may determine the shifted corresponding block 622 by shifting the co-located block 621 by as much as the median value mv_med, and then may determine the view direction motion vector of the shifted corresponding block 622 as the view direction skip motion vector of the current block 611.

When the view direction skip motion vector is generated according to the various processes described above with reference to FIGS. 4 through 6, the video encoding apparatus 200 according to the present exemplary embodiment may compare costs according to the processes of generating the view direction skip motion vector, may determine a view direction skip motion vector having an optimal (i.e., lowest) cost as a final view direction skip motion vector, and may encode only index information indicating the process of generating the corresponding view direction skip motion vector. For example, when it is assumed that a case of generating a view direction skip motion vector of a current block by using a view direction motion vector from among adjacent blocks of the current block is mode 0, a case of generating a view direction skip motion vector of a current block by using a view direction motion vector of a co-located block having the same view as the current block and included in another frame is mode 1, a case of using a view direction motion vector of a corresponding block obtained by shifting a co-located block having the same view as the current block and included in another frame is mode 2, a case of using a view direction motion vector of a co-located block included in a frame having a different view of a current block and having the same POC is mode 4, and a case of using a view direction motion vector of a corresponding block obtained by shifting a co-located block included in a frame having a different view of a current block and having the same POC is mode 5, the entropy encoding unit 250 may add only mode information to a bitstream, wherein the mode information is used to generate a final view direction skip motion vector of the current block. In the view direction skip mode, only the mode information is encoded, and in the view direction direct mode, information other than the mode information may be encoded, wherein the information is about residual data that is a difference value between the current block and a motion compensation value of the current block, which is obtained by using the view direction skip motion vector.

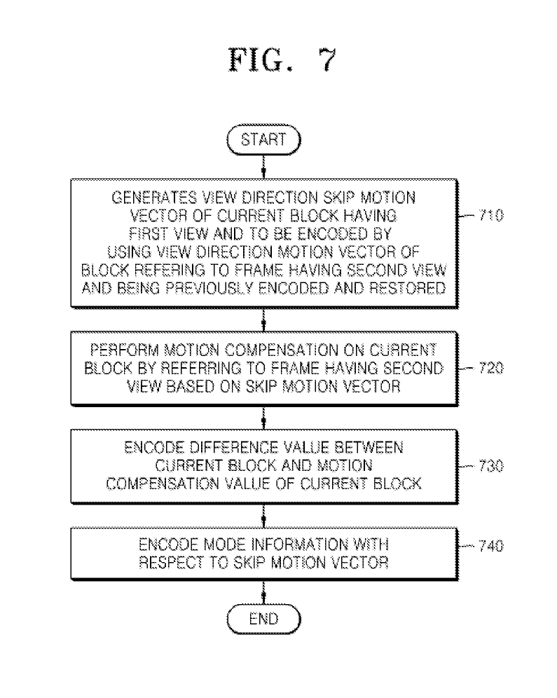

FIG. 7 is a flowchart of a method of encoding a multi-view video, according to an exemplary embodiment.

Referring to FIG. 7, in operation 710, the motion prediction unit 220 generates a view direction skip motion vector of a current block having a first view and to be encoded by using a view direction motion vector of a block referring to a frame that has a second view and is previously encoded and restored. As described above, the view direction skip motion vector may be determined by using the view direction motion vector of the adjacent block from among the adjacent blocks of the current block, by using a view direction motion vector of a co-located block having the same view as the current block and included in another frame, by using a view direction motion vector of a corresponding block obtained by shifting a co-located block having the same view as the current block and included in another frame, by using a view direction motion vector of a co-located block included in a frame having a different view from the current block and having the same POC, or by using a view direction motion vector of a corresponding block obtained by shifting a co-located block included in a frame having a different view from the current block and having the same POC.

In operation 720, the motion compensation unit 225 performs motion compensation on the current block by referring to the frame having the second view based on a skip motion vector.

In operations 730 and 740, the entropy encoding unit 250 encodes mode information about the skip motion vector. As described above, in a view direction skip mode, only the mode information is encoded, and in a view direction direct mode, information other than the mode information is encoded, wherein the information is about residual data that is a difference value between the current block and a motion compensation value of the current block, which is obtained by using the view direction skip motion vector.

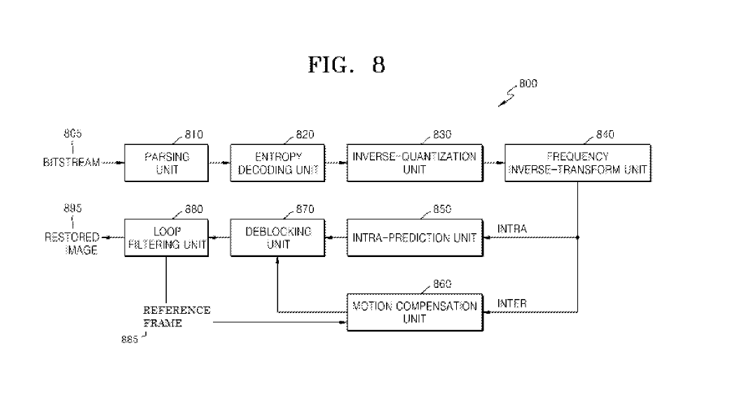

FIG. 8 is a block diagram illustrating a video decoding apparatus according to an exemplary embodiment.

Referring to FIG. 8, the video decoding apparatus 800 includes a parsing unit 810, an entropy decoding unit 820, an inverse-quantization unit 830, a frequency inverse-transform unit 840, an intra-prediction unit 850, a motion compensation unit 860, a deblocking unit 870, and a loop filtering unit 880.

While a bitstream 805 passes through the parsing unit 810, encoded multi-view image data to be decoded and information necessary for decoding are parsed. The encoded multi-view image data is output as inverse-quantized data by the entropy decoding unit 820 and the inverse-quantization unit 830, and image data in a spatial domain is restored by the frequency inverse-transform unit 840.

With respect to the image data in the spatial domain, the intra-prediction unit 850 performs intra-prediction on an intra-mode block, and the motion compensation unit 860 performs motion compensation on an inter-mode block by using a reference frame 885. In particular, in a case where prediction mode information of a current block to be decoded indicates a view direction skip mode, the motion compensation unit 860 according to the present exemplary embodiment generates a view direction skip motion vector of the current block having a first view and being to be decoded by using a view direction motion vector of a block referring to a frame that has a second view and is previously decoded, performs motion compensation on the current block by referring to the frame having the second view based on the view direction skip motion vector, and then directly determines a motion-compensated value as a restored value of the current block. If the prediction mode information of the current block indicates a view direction direct mode, the motion compensation unit 860 compensates for the current block by adding a residual value of the current block output from the frequency inverse-transform unit 840, and the motion-compensated value obtained by the view direction skip motion vector. A process of generating the view direction skip motion vector by using the motion compensation unit 860 is the same as the process of generating a view direction skip motion vector by using the motion prediction unit 220 which is described above with reference to FIG. 2, and thus, the detailed description is omitted.

The image data in the spatial domain that has passed through the intra-prediction unit 850 and the motion compensation unit 860 may be post-processed by the deblocking unit 870 and the loop filtering unit 880, and may be output as a restored frame 895. Also, post-processed data by the deblocking unit 870 and the loop filtering unit 880 may be output as a reference frame 885.

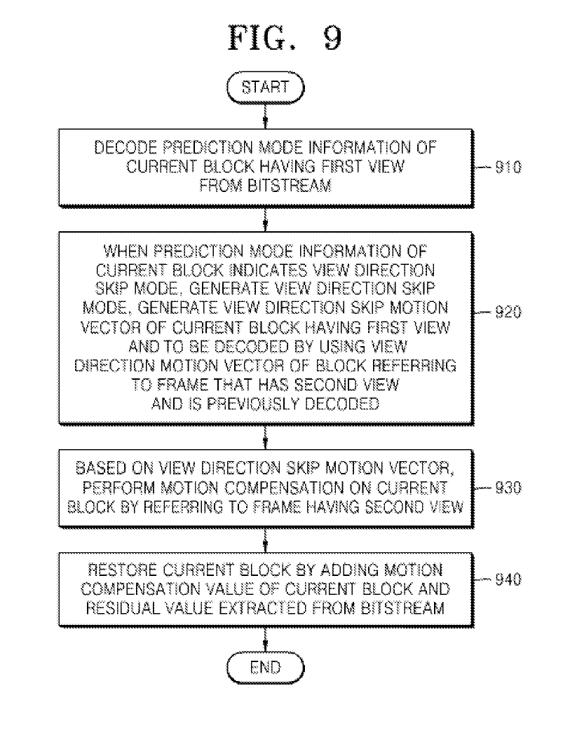

FIG. 9 is a flowchart of a method of decoding a video, according to an exemplary embodiment.

Referring to FIG. 9, in operation 910, the entropy decoding unit 820 decodes prediction mode information of a current block having a first view from a bitstream.

In operation 920, when the prediction mode information of the current block indicates a view direction skip mode, the motion compensation unit 860 generates a view direction skip motion vector of the current block having a first view and to be decoded by using a view direction motion vector of a block referring to a frame that has a second view and is previously decoded. Then, in operation 930, based on the view direction skip motion vector, the motion compensation unit 860 performs motion compensation on the current block by referring to the frame having the second view.

In operation 940, a motion compensation value of the current block and a residual value extracted from the bitstream are added, so that the current block is restored. Operation 940 is performed in a view direction direct mode, and in a case of a view direction skip mode, the motion compensation value corresponds to the restored current block so that operation 940 may be omitted.

The exemplary embodiments provide a skip mode in which a motion vector of a current block is predicted not only in a temporal direction but also in a view direction, and only mode information is transmitted. By doing so, a compression rate in coding a multi-view video may be increased.

The exemplary embodiments can also be embodied as computer-readable codes on a computer-readable recording medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, optical data storage devices, etc. The computer-readable recording medium can also be distributed over network-coupled computer systems so that the computer-readable code is stored and executed in a distributed fashion.

The exemplary embodiments may be embodied by an apparatus that includes a bus coupled to every unit of the apparatus, at least one processor (e.g., central processing unit, microprocessor, etc.) that is connected to the bus for controlling the operations of the apparatus to implement the above-described functions and executing commands, and a memory connected to the bus to store the commands, received messages, and generated messages.

As will also be understood by the skilled artisan, the exemplary embodiments, including units and/or modules thereof, may be implemented by any combination of software and/or hardware components, such as a Field Programmable Gate Array (FPGA) or Application Specific Integrated Circuit (ASIC), which performs certain tasks. A unit or module may advantageously be configured to reside on the addressable storage medium and configured to execute on one or more processors or microprocessors. Thus, a unit or module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and units may be combined into fewer components and units or modules or further separated into additional components and units or modules.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of encoding a multi-view video, the method comprising:
generating a view direction skip motion vector of a current block of the multi-view video, the current block having a first view and to be encoded by using a view direction motion vector of a block referring to a frame that has a second view and is previously encoded;
performing motion compensation on the current block by referring to the frame having the second view based on the view direction skip motion vector; and
encoding mode information about the view direction skip motion vector.

2. The method of claim 1, wherein a picture order count (POC) of the current block having the first view is the same as a POC of the second view.

3. The method of claim 1, wherein the generating comprises generating the view direction skip motion vector of the current block by using a view direction motion vector of an adjacent block that refers to the frame having the second view and that is from among adjacent blocks encoded before the current block.

4. The method of claim 3, wherein the adjacent block is selected from among a block disposed left to the current block, a block disposed above the current block, and blocks disposed at corners and encoded before the current block.

5. The method of claim 1, wherein the view direction skip motion vector of the current block comprises a median value of view direction motion vectors selected from among a view direction motion vector of a block disposed left to the current block and referring to the frame having the second view, a view direction motion vector of a block disposed above the current block and referring to the frame having the second view, and view direction motion vectors of blocks that are disposed at corners, that are encoded before the current block, and that refer to the frame having the second view.

6. The method of claim 5, wherein, when the block disposed left to the current block and referring to the frame having the second view, the block disposed above the current block, and the blocks disposed at the corners and encoded before the current block do not exist, the median value is calculated by setting a view direction motion vector of an adjacent block as 0, wherein the adjacent block is from among the adjacent blocks and that does not refer to the frame having the second view.

7. The method of claim 1, wherein the generating comprises generating the view direction skip motion vector of the current block by using a view direction motion vector of a co-located corresponding block of a frame other than a current frame of the current block, the co-located corresponding block having the first view.

8. The method of claim 1, wherein the generating comprises generating the view direction skip motion vector of the current block by shifting a co-located corresponding block comprised in a different frame from the current block based on a temporal direction motion vector of an adjacent block that refers to the different frame from a frame comprising the current block having the first view and that is from among the adjacent blocks encoded before the current block, and using a view direction motion vector of the shifted co-located corresponding block.

9. The method of claim 1, wherein the generating comprises generating the view direction skip motion vector of the current block by shifting a co-located corresponding block comprised in a frame having a same picture order count (POC) as the current block and having a third view that is different from the current block having the first view based on a view direction motion vector of an adjacent block that refers to the different frame from a frame comprising the current block having the first view and that is from among the adjacent blocks encoded before the current block, and using a view direction motion vector of the shifted co-located corresponding block.

10. The method of claim 1, wherein the encoding comprises encoding index information for identifying processes of generating the view direction skip motion vector of the current block, according to a predetermined index, and for indicating a process among the processes which is used to generate the view direction skip motion vector of the current block.

11. A method of decoding a multi-view video, the method comprising:
decoding from a bitstream prediction mode information of a current block of the multi-view video, the current block having a first view;
generating a view direction skip motion vector of the current block by using a view direction motion vector of a block referring to a frame that has a second view and is previously decoded;
performing motion compensation on the current block by referring to the frame having the second view, based on the view direction skip motion vector; and
restoring the current block by adding a motion compensation value of the current block and a residual value extracted from the bitstream.

12. The method of claim 11, wherein a picture order count (POC) of the current block having the first view is the same as a POC of the second view.

13. The method of claim 11, wherein the generating comprises generating the view direction skip motion vector of the current block by using a view direction motion vector of an adjacent block that refers to the frame having the second view and that is from among the adjacent blocks decoded before the current block.

14. The method of claim 13, wherein adjacent block is selected from among a block disposed left to the current block, a block disposed above the current block, and blocks disposed at corners and decoded before the current block.

15. The method of claim 11, wherein the view direction skip motion vector of the current block comprises a median value of view direction motion vectors selected from among a view direction motion vector of a block disposed left to the current block and referring to the frame having the second view, a view direction motion vector of a block disposed above the current block and referring to the frame having the second view, and view direction motion vectors of blocks that are disposed at corners, that are decoded before the current block, and that refer to the frame having the second view.

16. The method of claim 15, wherein, when the block disposed left to the current block and referring to the frame having the second view, the block disposed above the current block, and the blocks disposed at the corners and decoded before the current block do not exist, the median value is calculated by setting a view direction motion vector of an adjacent block as 0, wherein the adjacent block is from among the adjacent blocks and that does not refer to the frame having the second view.

17. The method of claim 11, wherein the generating comprises generating the view direction skip motion vector of the current block by using a view direction motion vector of a co-located corresponding block of a frame other than a current frame of the current block, the co-located corresponding block having the first view.

18. The method of claim 11, wherein the generating comprises generating the view direction skip motion vector of the current block by shifting a co-located corresponding block comprised in a different frame from the current block based on a temporal direction motion vector of an adjacent block that refers to the different frame from a frame comprising the current block having the first view and that is from among the adjacent blocks decoded before the current block, and using a view direction motion vector of the shifted co-located corresponding block.

19. The method of claim 11, wherein the generating comprises generating the view direction skip motion vector of the current block by shifting a co-located corresponding block comprised in a frame having a same picture order count (POC) as the current block and having a third view that is different from the current block having the first view based on a view direction motion vector of an adjacent block that refers to the different frame from a frame comprising the current block having the first view and that is from among the adjacent blocks encoded before the current block, and using a view direction motion vector of the shifted co-located corresponding block.

20. The method of claim 11, wherein, when the current block is encoded by using a view direction skip motion vector, the prediction mode information comprises predetermined index information for identifying processes of generating the view direction skip motion vector of the current block.

21. A video encoding apparatus for encoding a multi-view video, the video encoding apparatus comprising:
a prediction unit that generates a view direction skip motion vector of a current block of the multi-view video, the current block having a first view and to be encoded by using a view direction motion vector of a block referring to a frame that has a second view and is previously encoded and restored;
a motion compensation unit that performs motion compensation on the current block by referring to the frame having the second view based on the view direction skip motion vector; and
an entropy encoding unit encoding mode information about the view direction skip motion vector.

22. A video decoding apparatus for decoding a multi-view video, the video decoding apparatus comprising:
an entropy decoding unit that decodes from a bitstream prediction mode information of a current block of the multi-view video, the current block having a first view;
a motion compensation unit that, when the prediction mode information indicates a view direction skip mode, generates a view direction skip motion vector of the current block by using a view direction motion vector of an adjacent block from among adjacent blocks of the current block having the first view and being to be decoded, wherein the adjacent block refers to a frame that has a second view and is previously decoded, and that performs motion compensation on the current block by referring to the frame having the second view, based on the view direction skip motion vector; and
a restoring unit that restores the current block by adding a motion compensation value of the current block and a residual value extracted from the bitstream.

23. A view direction prediction encoder that encodes a multi-view image, the view direction prediction encoder comprising:
a prediction unit that (i) encodes a first picture of the multi-view image, the first picture having a first view obtained from a first image capturing device, and (ii) encodes a current block of a second picture of the multi-view image using the first picture as a reference picture, the second picture having a second view obtained from a second image capturing device that is different from the first view obtained by the first image capturing device.

24. The view direction prediction encoder according to claim 22, wherein the prediction unit encodes the current block by generating a view direction skip motion vector of the current block, the view direction skip motion vector identifying a corresponding region of the reference picture that is most similar to the current block.

25. The view direction prediction encoder according to claim 23, wherein the generating the view direction skip motion vector comprises determining as the view direction skip motion vector a view direction motion vector of at least one adjacent block that is adjacent to the current block, the view direction motion vector identifying a reference block of the first picture used to prediction encode the adjacent block.

26. The view direction prediction encoder according to claim 24, wherein the at least one adjacent block comprises a plurality of adjacent blocks and the view direction motion vector comprises a plurality of view direction motion vectors of the plurality of adjacent blocks that identify reference blocks of the first picture used to prediction encode the plurality of adjacent blocks, and
wherein the generating further comprises selecting one of the plurality of view direction motion vectors as the view direction skip motion vector.

27. The view direction prediction encoder according to claim 25, further comprising a motion compensation unit that determines the corresponding region as a prediction value of the current block and performs motion compensation on the current block based on the corresponding region.

28. The view direction prediction encoder according to claim 26, further comprising an entropy encoding unit that determines to encode the current block in one of a view direction skip mode and a view direction direct mode, and one of (i) encodes only syntax information that indicates the view direction skip mode if it is determined to encode the current block in the view direction skip mode, and (ii) encodes residual information that is a difference between the corresponding region and the current block and syntax information that indicates the view direction direct mode if it is determined to encode the current block in the view direction direct mode.

29. The view direction prediction encoder according to claim 23, wherein the generating the view direction skip motion vector comprises determining as the view direction skip motion vector a view direction motion vector of a co-located block of a frame of the second picture that is different from a current frame of the current block, the view direction motion vector identifying a corresponding region of the reference picture that is most similar to the co-located block.

30. The view direction prediction encoder according to claim 23, wherein the generating the view direction skip motion vector comprises:
determining a view direction motion vector of a co-located block of a frame of the second picture that is different from a current frame of the current block, the view direction motion vector identifying a corresponding region of the reference picture that is most similar to the co-located block;
determining a temporal direction motion vector of an adjacent block that is adjacent to the current block, the temporal direction motion vector referring to frame;
shifting the co-located block according to the temporal direction motion vector; and
setting as the view direction skip motion vector a view direction motion vector of the shifted co-located block.

31. The view direction prediction encoder according to claim 23, wherein the generating the view direction skip motion vector comprises determining as the view direction skip motion vector a view direction motion vector of a co-located block of a frame of the first picture, the view direction motion vector identifying a corresponding region of a third picture that is most similar to the co-located block, the third picture having a third view obtained from a third image capturing device that is different from the first view and the second view obtained by the first image capturing device and the second image capturing device.

32. The view direction prediction encoder according to claim 23, wherein the generating the view direction skip motion vector comprises:
determining a view direction motion vector of a co-located block of a frame of the first picture, the view direction motion vector identifying a corresponding region of a third picture that is most similar to the co-located block, the third picture having a third view obtained from a third image capturing device that is different from the first view and the second view obtained by the first image capturing device and the second image capturing device;
determining a temporal direction motion vector of an adjacent block that is adjacent to the current block, the temporal direction motion vector referring to frame;
shifting the co-located block according to the temporal direction motion vector; and
setting as the view direction skip motion vector a view direction motion vector of the shifted co-located block.

33. The view direction prediction encoder according to claim 23, wherein the generating the view direction skip motion vector comprises:
determining at least two of (i) a first view direction motion vector of at least one adjacent block that is adjacent to the current block, the first view direction motion vector identifying a reference block of the first picture used to prediction encode the adjacent block, (ii) a second view direction motion vector of a first co-located block of a frame of the second picture that is different from a current frame of the current block, the second view direction motion vector identifying a corresponding region of the reference picture that is most similar to the first co-located block, and (iii) a third view direction motion vector of a second co-located block of a frame of the first picture, the view direction motion vector identifying a corresponding region of a third picture that is most similar to the second co-located block, the third picture having a third view obtained from a third image capturing device that is different from the first view and the second view obtained by the first image capturing device and the second image capturing device; and
determining as the view direction skip motion vector one of the at least two of the first view direction motion vector, the second view direction motion vector, and the third view direction motion vector having a lowest cost for encoding the current block.

34. A view direction prediction decoder that decodes a multi-view image, the view direction prediction decoder comprising:
a decoding unit that (i) receives a bitstream, the bitstream comprising an encoded first picture of the multi-view image, the first picture having a first view obtained from a first image capturing device, and an encoded current block of a second picture of the multi-view image that is encoded using the first picture as a reference picture, the second picture having a second view obtained from a second image capturing device that is different from the first view obtained by the first image capturing device, and (ii) decodes the current block using the first picture.

35. The view direction prediction decoder according to claim 33, wherein the decoding unit obtains from the bitstream prediction mode information of the current block of the multi-view video that indicates an encoding mode of the current block, and decodes the current block using the first picture based on the encoding mode indicated by the prediction mode information.
